(19) United States
(12) Patent Application Publication
(10) Pub. No.: US 2026/0301332 A1
(43) Pub. Date: Oct. 1, 2026

(54) SYSTEM, METHOD, AND COMPUTER-PROGRAM PRODUCT FOR PLACING A DIGITALLY-CREATED TOKEN IN AN AUGMENTED REALITY (AR) ENVIRONMENT

(71) Applicant: Prism AR, Inc., Boynton Beach, FL (US)

(72) Inventors: Yiftah Frechter, Irvington, NY (US); Brett Farrell Perloff, New York, NY (US); John Robert Ruhlen, San Francisco, CA (US)

(21) Appl. No.: 19/097,143

(22) Filed: Apr. 1, 2025

(51) Int. Cl. G06T 19/00; G06Q 30/0241; G06T 19/20

(52) U.S. Cl. CPC G06T 19/006; G06Q 30/0276; G06T 19/20; G06T 2219/2004

(57) ABSTRACT

The present application pertains to systems, methods, and computer-program products for placing a digitally-created token in an augmented reality (AR) environment. More particularly, embodiments relate to systems, methods and processes for placing select digital representations of objects or advertisements in appropriate locations in the AR environment.

### FIELD OF THE INVENTION

Embodiments described herein are employed for identifying a location for placing a digitally-created token in a stream AR scene, selecting a digitally-created token for placement, and placement of the selected digitally-created token such that it is visible in the streamed AR scene. In some instances the digitally-created token is a digital representation of an object, In some instances, the digitally-created token is an advertisement.

### BACKGROUND

As AR and AR devices become more popular in everyday life, it offers an opportunity for visualizing digitally-created tokens in scenes of tangible and real environments. In particular, it is desirable to select a location for inclusion of the digitally-created object in the scene such that it does not interfere with or otherwise obstruct tangible and “real world” objects, structures, and the like. It is also desirable that the digitally-created token, whether a digital representation of an object or a digital advertisement, be appropriate for the scene. As such, it is desirable to select and display the digitally-created token based on parameters of the scene

Therefore, there is a need for systems, processes, and computer-program products meet challenges in the present state of the art, some of which are described above.

### SUMMARY

In one aspect, a method [THIS SECTION WILL BE COMPLETED WHEN THE CLAIMS ARE FINALIZED]

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is an example of a system for placing a digitally-created token in an augmented reality (AR) environment.

FIG. 1B illustrates another example of a system for placing a digitally-created token in an environment where the server is in direct communication with the database.

FIG. 1C is an exemplary graphical illustration of a database look-up process that may be performed by the device and/or the server.

FIG. 1D illustrates another example of a system for placing a digitally-created token in an environment where the server is in communication to a real-time bidding (RTB) process.

FIG. 1E illustrates one example of an RTB process.

FIG. 1F shows an event trace diagram for an exemplary RTB process.

FIG. 2A is an exemplary event trace diagram for ad placement using systems described herein.

FIG. 2B is an overview block diagram of the exemplary process shown in FIG. 2A.

FIG. 3 is a flowchart for an exemplary method for placing a digitally-created token in an AR environment.

FIG. 4 illustrates an example computing environment in which example embodiments and aspects may be implemented.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes¬ from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

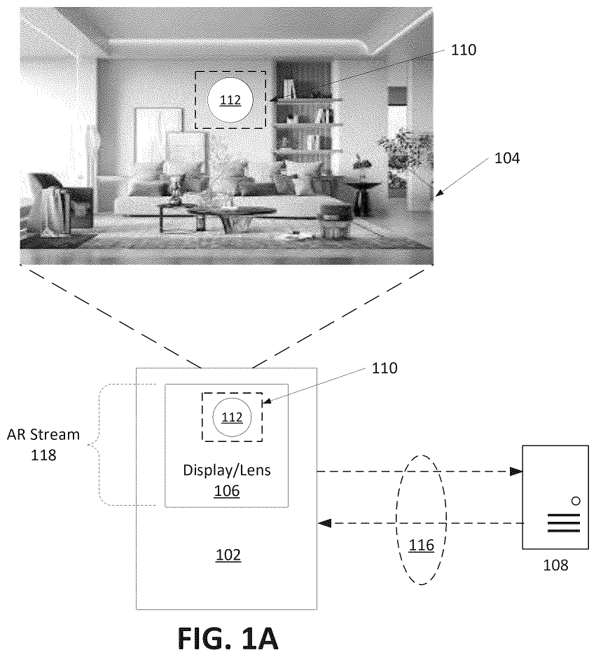

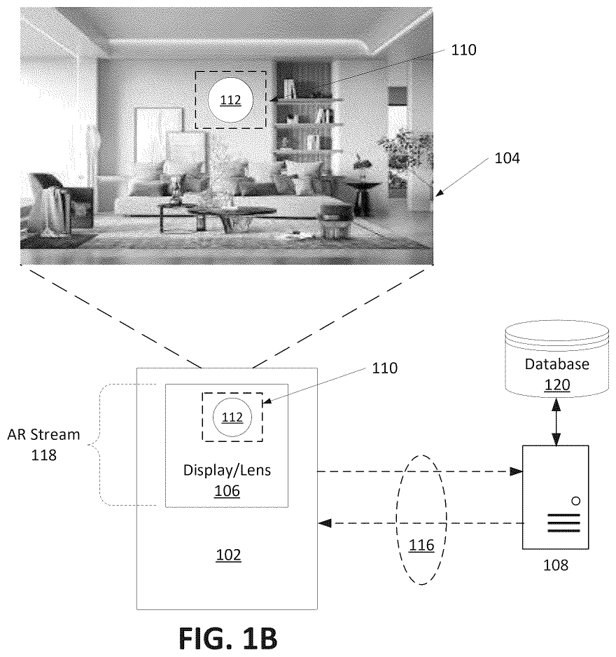

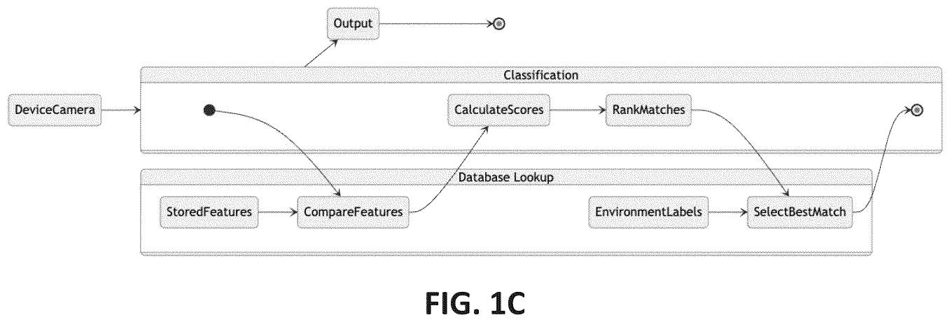

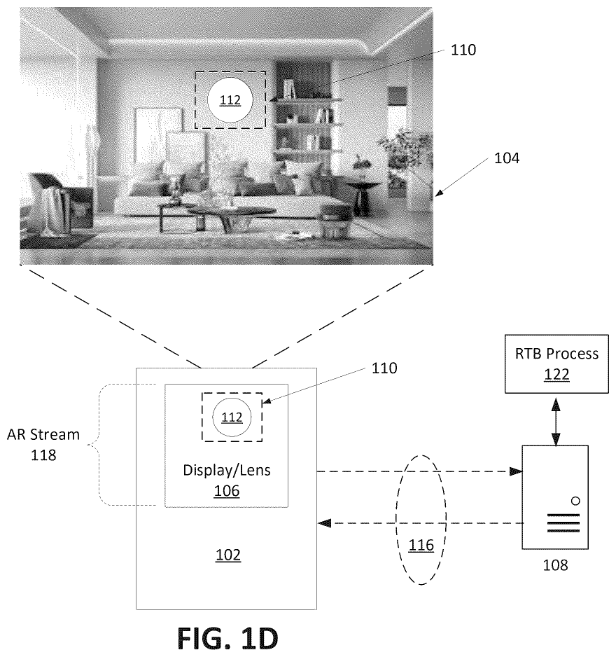

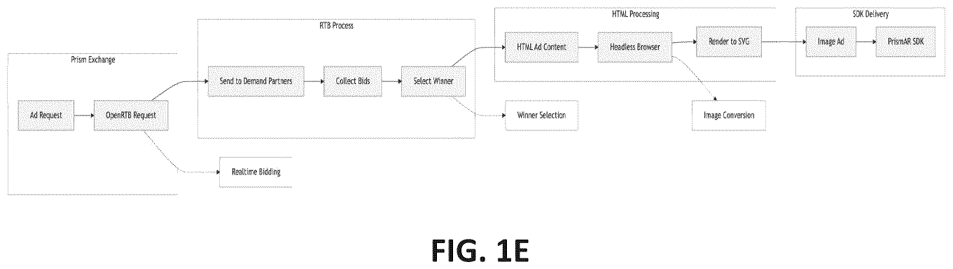

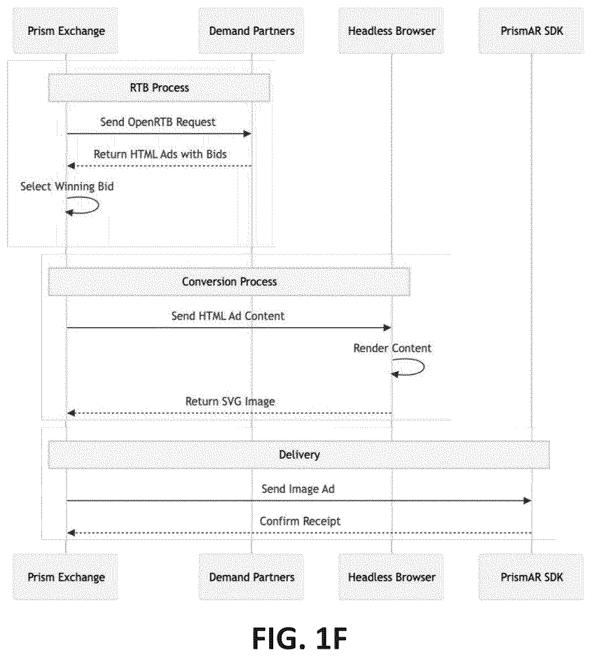

FIG. 1A is an example of a system for placing a digitally-created token in an augmented reality (AR) environment. As shown in FIG. 1A, the system is comprised of a device 102 configured for viewing an AR stream 118 of a scene 104. In some instances, the scene 104 is captured by a camera (not shown) or viewed through a lens (not shown), or otherwise made visible on a display or lens 106 of the device 102. In some instances, the scene 104 may be streamed in real-time, near real-time, or recorded and streamed at a later time. In various instances, the device 102 may comprise devices configured to overlay digital information onto the real world such as a smartphone, a computer (laptop or desktop), virtual reality (VR) or AR smart glasses, masks, headsets, and the like. Such devices may include but are not limited to Microsoft HoloLens™, Magic Leap™, Google Glass™, Meta Quest™, Vuzix Blade™, and the like. Other instances of the device may comprise intelligent or smart technology such as intelligent windows and intelligent/smart windshields.

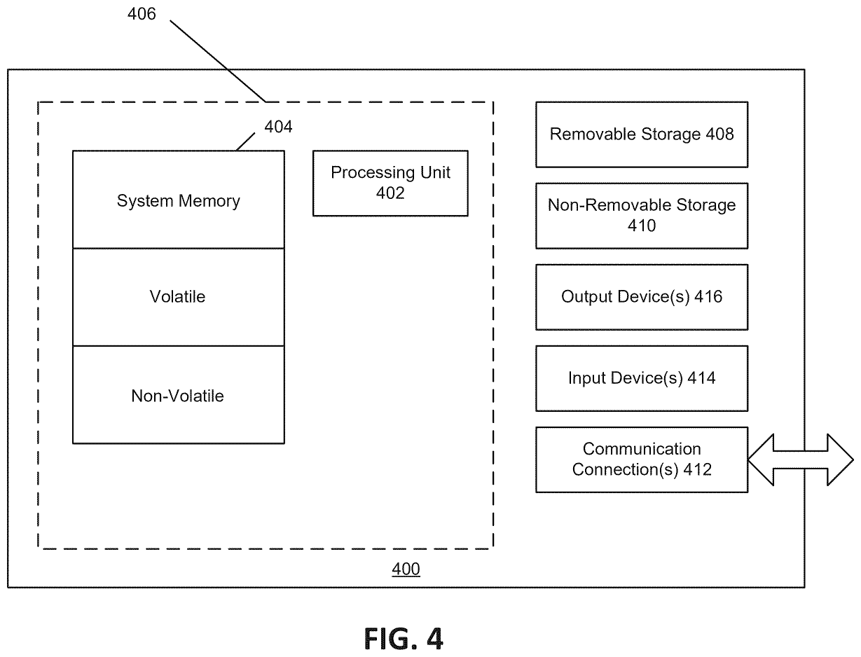

In some instances, the device 102 comprises one or more processors in communication with one or more computer-readable mediums (see, for example, FIG. 4). In other instances, the device 102 is in communication with one or more servers 108. In some instances, the one or more servers 108 may comprise all or a portion of a cloud-based computing system. Generally, the device 102 is in communication with the server 108 through a bi-directional network 116, typically a wireless network, though wired (including fiber optic) networks are contemplated within the scope of this disclosure. As with the device 102, the server 108 may comprise one or more processors in communication with one or more computer-readable mediums. The one or more processors of the device 102, the server 108, and/or a combination of the device 102 and the server 108 execute computer-executable code sections stored on the one or more computer-readable mediums to cause the one or more processors to receive the AR stream 118 of the scene 104; analyze the scene 104 for one or more location opportunities (such as the location opportunity 110 shown in the scene 104 of FIG. 1A) for placement of a digitally-created token 112 in the scene 104; and place the digitally-created token 112 at one of the one or more location opportunities 110 in the scene 104 such that the digitally-created token 112 is visible in the AR stream 118.

The one or more processors of the device 102, the server 108, and/or a combination of the device 102 and the server 108 executing computer-executable code sections stored on the one or more computer-readable mediums to cause the one or more processors to analyze the scene for one or more location opportunities for placement of the digitally-created token 112 in the scene 104 comprises executing code sections for detecting surfaces in the scene 104, calculating positions for placement of the digitally-created token 112 in the scene 104, and defining constraints for placement of the digitally-created token 112 in the scene. Defining constraints for placement of the digitally-created token 112 in the scene 104 comprises determining eligibility for placement of the digitally-created token 112 in the scene. In some instances, determining eligibility for placement of the digitally-created token 112 in the scene 104 comprises determining one or more of sizes of the detected surfaces, angles of the detected surfaces, lighting characteristics of the detected surfaces, stability of the detected surfaces in the scene, and the like. For example, in some instances analyzing the scene may comprise determining whether the scene 104 is indoors or outdoors. Analyzing the scene may comprise determining location information about the scene. For example, a location such as a restaurant, a retail store, an indoor sporting event, a theater or other indoor entertainment venue, a gym, an indoor adventure setting such as a bowling alley, and indoor pool, a skating rink, a location for participating in other indoor activities, and the like may be determined. Similarly, analyzing the scene may comprise that the scene comprises identifying a room of a dwelling including a kitchen, a living room, a den, a bedroom, a dining, room, a bathroom, a laundry room, a basement, a foyer, a hallway, a staircase, an attic, a closet, a storage room, a garage, and the like.

Similarly, analyzing the scene may comprise determining whether the scene comprises a rural setting, an urban setting, a city setting, a sporting event, a concert or other outdoor entertainment venue, a vacation setting such as a beach, sea or ocean setting or a mountain setting, an outdoor adventure setting such as hunting, fishing, hiking, camping, a location for participating in other outdoor activities, and the like.

In some instances, the analysis of the scene may be performed by artificial intelligence (AI), including machine learning. The AI may be trained on a dataset of scenes to recognize location opportunities. The AI may assign a probability to various locations to rank their acceptability as location opportunities, where the location(s) with the highest probability may be selected. The AI may detect surfaces in the scene 104, calculate positions for placement of the digitally-created token 112 in the scene 104, and define constraints for placement of the digitally-created token 112 in the scene. Or, in some instances, the AI may pass the identified potential location opportunities to code sections that detect surfaces in the scene 104, calculate positions for placement of the digitally-created token 112 in the scene 104, and define constraints for placement of the digitally-created token 112 in the scene.

In some instances, the digitally-created token 112 comprises a digitally-created rendering of an object. The object may comprise, for example, furniture, electronics, automobiles, artwork, books, window treatments, windows, a fireplace, appliances, food, containers including alcoholic beverage containers, glassware, dishes, silverware, cookware, toys, doors, staircases, cabinets, shelves, and the like, or combinations of such objects. Objected may be selected for placement in the scene 104 at least in part based on the determined scene and location. For example, placing a digitally-created token 112 of an operating chainsaw would typically not be appropriate if the scene were determined to be an interior of an upscale apartment, though such a digitally-created token 112 may be selected in some instance for dramatic effect in the scene 104. Regardless, the object is virtual, but shown in the scene 104 as if it were a real, physical object existing in the scene 104.

In some instances, the digitally-created token 112 may comprise an advertisement. In some instances the advertisement may be combined with an object, as described above. For example, the object may be a promotional object associated with the advertisement. In such instances, the one or more processors in communication with one or more computer-readable mediums execute computer-executable code sections stored on the one or more computer-readable mediums to cause the one or more processors to create an advertising package. Generally, the advertising package is comprised of parameters including the determined sizes of the detected surfaces, angles of the detected surfaces, lighting characteristics of the detected surfaces, and stability of the detected surfaces in the scene. In some instances, the advertising package may be created by properly-trained AI. The advertising package is generally provided by the device 102 to a server, such as server 108, or in some instances the advertising package is created by server 108 from information transmitted to the server 108 by the device 102, and then provided to another server, such as an ad server. In either instance, the server 108 (or an ad server) selects one of the detected surfaces and an advertisement is selected for placement on the selected detected surface in the scene based on the advertising package. This typically comprises creating an anchor on the selected detected surface, rendering the selected advertisement on the selected detected surface in the scene 104, and displaying the selected advertisement. Typically, the selected advertisement is shown in the scene 104 on the display/lens 106 of the device 102.

In some instances the system further comprises a database 120. In FIG. 1B, the server 108 is in direct communication with the database 120. In other instances, not shown in FIG. 1B, the database 120 may be in direct communication with the device 102 rather than the server 108. Though shown as one database 120, it is to be appreciated that a plurality of database that may or may not be located in disparate locations is contemplated in this disclosure. A plurality of digitally-created advertisements are stored in the database 120, each stored advertisement having a plurality of stored features, wherein the server 108, for example, uses the one or more processors in communication with one or more computer-readable mediums execute computer-executable code sections stored on the one or more computer-readable mediums to cause the one or more processors to compare parameters of the advertising package to the stored features of a plurality of stored advertisements to create a score indicative of a match between the advertising package and each of the plurality of stored advertisements, the scores are ranked, and the stored advertisement most closely associated with the parameters of the advertising package as determined by the ranking is selected. FIG. 1C is an exemplary graphical illustration of the above-described database look-up process that may be performed by the device 102 and/or the server 108.

In other instances, as shown in FIG. 1D, the server 108, for example, comprising the one or more processors in communication with one or more computer-readable mediums executing computer-executable code sections stored on the one or more computer-readable mediums to cause the one or more processors to provide the advertising package to a real-time bidding (RTB) process 122. The RTB process 122 comprises a plurality of advertisers that bid to place an advertisement in the scene 104 based on the advertisement package provided to the RTB process 122. In such instances, one of the detected surfaces in the scene 104 is selected and the advertisement is selected for placement on the selected detected surface in the scene 104 based on a highest bid among the plurality of advertisers and parameters of the advertising package. Placing the selected advertisement in the scene comprises creating an anchor on the selected detected surface, processing advertisement content received from the highest bidder among the plurality of advertisers, rendering the selected advertisement on the selected detected surface in the scene, and displaying the selected advertisement on a display/lens 106 of the device 102 configured for viewing the AR stream of the scene 104.

FIG. 1E illustrates one example of an RTB process 122, as described herein, and FIG. 1F shows an event trace diagram for an exemplary RTB process 122.

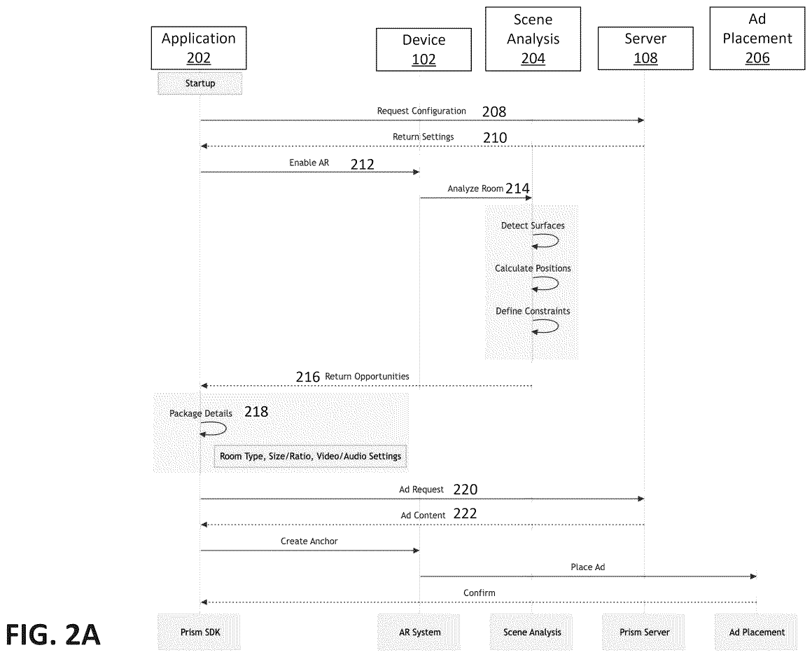

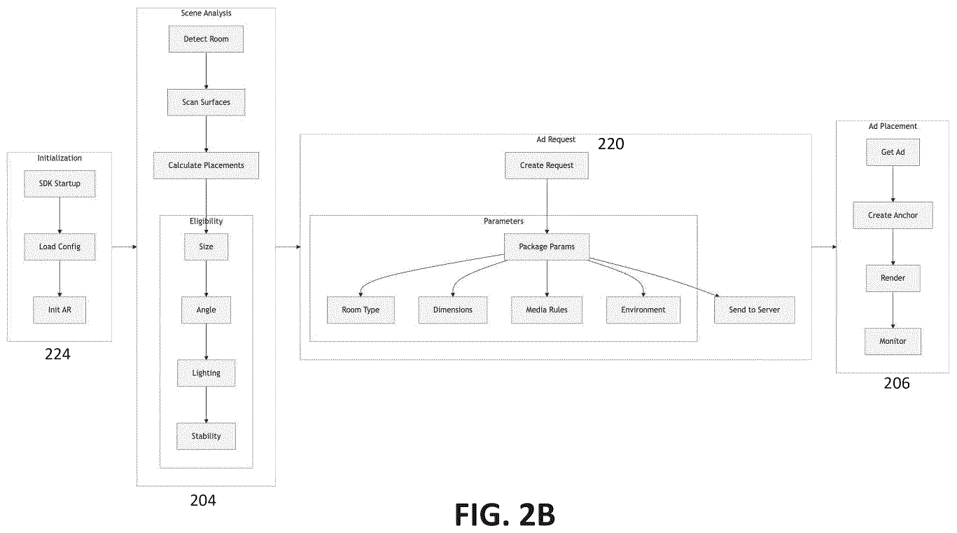

FIG. 2A is an exemplary event trace diagram for ad placement using the above-described systems shown in FIGS. 1B-1D. As shown in FIG. 2A, at startup an application (app) 202 executing on the device 102 sends a configuration request 208 to the server 108, and setting are returned 210 from the server 108 to the device 102 and app 202. The application 202 in cooperation with the device 102 enables the augmented reality (AR) environment and starts the AR stream 212. Scene analysis 204 then begins. Assuming the scene is indoors, scene analysis 204 involves room analysis 214. Room analysis 212 may be performed by the app 202 and the device 102, by the device alone, by the server 108 alone, by the device 102 and the server 108 cooperatively, and/or by the app 202, the device 102 and the server 108, cooperatively. Room analysis 214 analyzes the AR stream to find location opportunities in the scene 104 based at least on detecting surfaces in the scene, calculation positions of location opportunities in the scene 104, and defining constraints for placing the advertisement in the scene 104. The results of the scene analysis 204 are returned to the app 202, which identifies location opportunities 216 in the scene 104.

The app 202 then creates an advertisement package 218, which may include room type, size/ration of the location opportunities, video/audio settings for the advertisement, and the like. The advertising package 218 is used to create an ad request 220, which is sent from the app 202 to the server 108. As shown in FIGS. 1B-1D, the server 108 and/or the devise 102 selects an advertisement for placement in the scene 108. In some instances, this involves selecting an advertisement from a database 120 based on comparing features of the ad request 220 to features of the advertisements stored in the database (see FIGS. 1B and 1C). In other instances, the advertisement is selected for placement in the scene 104 based on a real-time bidding (RTB) process, where bidders use the information in the ad request 220 to make bids on placing their advertisement in the scene 104. Ad content 222 from the selected advertisement, whether selected form the database or selected through the RTB process, is returned to the app 202 in response to the ad request 220.

Ad placement 206 then occurs. Ad placement 206 involves creating an anchor on the selected detected surface, rendering the selected advertisement on the selected detected surface in the scene 104, and displaying the selected advertisement. Typically, the selected advertisement is shown in the scene 104 on the display/lens 106 of the device 102.

FIG. 2B is an overview block diagram of the exemplary process shown in FIG. 2A, showing the steps of initialization 224 of the app 202 and device 102, scene analysis 204 as performed by the device 102, the server 108, or cooperatively by the device 102 and the server 108, creating the advertisement package and making the ad request 220, and the ultimate ad selection and ad placement 206.

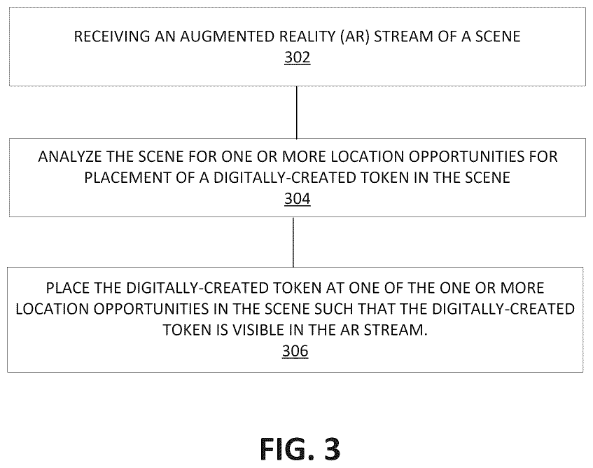

FIG. 3 is a flowchart for an exemplary method for placing a digitally-created token in an augmented reality (AR) environment. The method comprises 302, receiving an augmented reality (AR) stream of a scene. The AR stream may be in real-time, near real-time, or previously record and being played bac. At 304, the scene, via the AR stream, is analyzed for one or more location opportunities for placement of a digitally-created token in the scene. At 306, a selected digitally-created token is placed at one of the one or more location opportunities in the scene such that the digitally-created token is visible in the AR stream.

In some instances, the digitally-created token comprises a digitally-created rendering of an object. The object may comprise, for example, digital representations of furniture, electronics, automobiles, artwork, books, window treatments, windows, a fireplace, appliances, food, containers including alcoholic beverage containers, glassware, dishes, silverware, cookware, toys, doors, staircases, cabinets, shelves, and the like.

In some instances, analyzing the scene for one or more location opportunities for placement of a digitally-created token in the scene comprises detecting surfaces in the scene, calculating positions for placement of the digitally-created token in the scene, and defining constraints for placement of the digitally-created token in the scene. Defining constraints for placement of the digitally-created token in the scene may comprise determining eligibility for placement of the digitally-created token in the scene. Determining eligibility for placement of the digitally-created token in the scene may comprise determining one or more of sizes of the detected surfaces, angles of the detected surfaces, lighting characteristics of the detected surfaces, and stability of the detected surfaces in the scene. Analyzing the scene may comprise determining whether the scene is indoors or outdoors. In some instances, analyzing the scene comprises determining a location of the scene such as a restaurant, a retail store, an indoor sporting event, a theater or other indoor entertainment venue, a gym, an indoor adventure setting such as a bowling alley, and indoor pool, a skating rink, or participating in other indoor activities [, and the like. In some instances, determining the location may comprise identifying a room of a dwelling including a kitchen, a living room, a den, a bedroom, a dining, room, a bathroom, a laundry room, a basement, a foyer, a hallway, a staircase, an attic, a closet, a storage room, a garage, and the like.

Similarly, in some instances, analyzing the scene may comprise determining whether the scene is a rural setting, an urban setting, a city setting, a sporting event, a concert or other outdoor entertainment venue, a vacation setting such as a beach, sea or ocean setting or a mountain setting, an outdoor adventure setting such as hunting, fishing, hiking, camping, or participating in other outdoor activities, and the like.

In some instances, the digitally-created token comprises a digitally-created advertisement. In such instances, the method further comprises creating an advertising package, wherein the advertising package is comprised of parameters including the determined sizes of the detected surfaces, angles of the detected surfaces, lighting characteristics of the detected surfaces, and stability of the detected surfaces in the scene. The method then comprises selecting one of the detected surfaces and an advertisement is selected for placement on the selected detected surface in the scene based on the advertising package. Placing the selected advertisement in the scene comprises creating an anchor on the selected detected surface, rendering the selected advertisement on the selected detected surface in the scene, and displaying the selected advertisement.

In some instances, a plurality of digitally-created advertisements are stored in a database, each stored advertisement having a plurality of stored features, and the parameters of advertising package are compared to the stored features of a plurality of stored advertisements to create a score indicative of a match between the advertising package and each of the plurality of stored advertisements. The scores are ranked, and the stored advertisement most closely associated with the parameters of the advertising package as determined by the ranking is selected for placement in the scene.

In other instances, the advertising package is provided to a real-time bidding process where a plurality of advertisers bid to place an advertisement in the scene based on the advertisement package. One of the detected surfaces is selected and the advertisement is selected for placement on the selected detected surface in the scene based on a highest bid among the plurality of advertisers and parameters of the advertising package. As with the above, placing the selected advertisement in the scene comprises creating an anchor on the selected detected surface, processing advertisement content received from the highest bidder among the plurality of advertisers, rendering the selected advertisement on the selected detected surface in the scene, and displaying the selected advertisement.

The above-described method may also be embodied in a non-transitory computer program product comprised of computer-executable code sections stored on one or more computer-readable mediums for implementing the method for placing a digitally-created token in an augmented reality (AR) environment.

FIG. 4 illustrates an example computing environment in which example embodiments and aspects may be implemented. The illustrated computing device may comprise all or part of a cloud-based network and/or a processor associated with the device 102 as described herein. As used herein, “computer,” “processor,” and “computing device” may refer to a singular device and/or may refer to a plurality of “computers,” “processors,” and “computing devices.” The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, cloud-based systems, microprocessor-based systems, network personal computers (PCs), minicomputers, mainframe computers, embedded systems, distributed computing environments that include any of the above systems or devices, and the like. The computing environment may include a cloud-based computing environment.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an example system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 400. Any such computer storage media may be part of computing device 400.

Computing device 400 may contain communication connection(s) 412 that allow the device to communicate with other devices and/or systems. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The inventive concepts describe in this disclosure include, but are not limited to:
1. A method for placing a digitally-created token in an augmented reality (AR) environment, comprising:
   receiving, in real-time or near real-time, an augmented reality (AR) stream of a scene;
   analyzing the scene for one or more location opportunities for placement of a digitally-created token in the scene; and
   placing the digitally-created token at one of the one or more location opportunities in the scene such that the digitally-created token is visible in the AR stream.
2. Inventive concept 1, wherein the digitally-created token comprises a digitally-created rendering of an object.
3. Inventive concept 1 or 2, wherein analyzing the scene for one or more location opportunities for placement of a digitally-created token in the scene comprises detecting surfaces in the scene, calculating positions for placement of the digitally-created token in the scene, and defining constraints for placement of the digitally-created token in the scene.
4. Inventive concept 3, wherein defining constraints for placement of the digitally-created token in the scene comprises determining eligibility for placement of the digitally-created token in the scene.
5. Inventive concept 4, wherein determining eligibility for placement of the digitally-created token in the scene comprises determining one or more of sizes of the detected surfaces, angles of the detected surfaces, lighting characteristics of the detected surfaces, and stability of the detected surfaces in the scene.
6. Any one of Inventive Concepts 1-5, wherein the analyzing the scene includes determining whether the scene comprises a restaurant, a retail store, an indoor sporting event, a theater or other indoor entertainment venue, a gym, an indoor adventure setting such as a bowling alley, and indoor pool, a skating rink, or a location for participating in other indoor activities.
7. Inventive Concept 6, wherein analyzing the scene further includes identifying a room of a dwelling including a kitchen, a living room, a den, a bedroom, a dining, room, a bathroom, a laundry room, a basement, a foyer, a hallway, a staircase, an attic, a closet, a storage room, and a garage.
8. Any one of Inventive Concepts 5-7, wherein analyzing the scene includes determining whether the scene comprises a rural setting, an urban setting, a city setting, a sporting event, a concert or other outdoor entertainment venue, a vacation setting such as a beach, sea or ocean setting or a mountain setting, an outdoor adventure setting such as hunting, fishing, hiking, camping, or a location for participating in other outdoor activities.
9. Inventive Concept 5, wherein the digitally-created token comprises an advertisement.
10. Inventive Concept 9, further comprising creating an advertising package, wherein the advertising package is comprised of parameters including the determined sizes of the detected surfaces, angles of the detected surfaces, lighting characteristics of the detected surfaces, stability of the detected surfaces in the scene.
11. Inventive Concept 10, wherein one of the detected surfaces is selected and an advertisement is selected for placement on the selected detected surface in the scene based on the advertising package.
12. Inventive concept 11, wherein placing the selected advertisement in the scene comprises creating an anchor on the selected detected surface, rendering the selected advertisement on the selected detected surface in the scene, and displaying the selected advertisement.
13. Inventive Concept 11, wherein a plurality of digitally-created advertisements are stored in a database, each stored advertisement having a plurality of stored features, wherein the parameters of advertising package are compared to the stored features of a plurality of stored advertisements to create a score indicative of a match between the advertising package and each of the plurality of stored advertisements, said scores are ranked, and the stored advertisement most closely associated with the parameters of the advertising package as determined by the ranking is selected.
14. Inventive Concept 10, wherein the advertising package is provided to a real-time bidding process, and wherein a plurality of advertisers bid to place an advertisement in the scene based on the advertisement package.
15. Inventive Concept 14, wherein one of the detected surfaces is selected and the advertisement is selected for placement on the selected detected surface in the scene based on a highest bid among the plurality of advertisers and parameters of the advertising package.
16. Inventive Concept 15, wherein placing the selected advertisement in the scene comprises creating an anchor on the selected detected surface, processing advertisement content received from the highest bidder among the plurality of advertisers, rendering the selected advertisement on the selected detected surface in the scene, and displaying the selected advertisement.
17. A non-transitory computer program product comprised of computer-executable code sections stored on one or more computer-readable mediums for implementing a method for placing a digitally-created token in an augmented reality (AR) environment, comprising:
   a first computer-executable code section for receiving an AR stream of a scene in real-time or near real-time;
   a second computer-executable code section for analyzing the scene for one or more location opportunities for placement of a digitally-created token in the scene; and
   a third computer-executable code section for placing the digitally-created token at one of the one or more location opportunities in the scene such that the digitally-created token is visible in the AR stream.
18. Inventive Concept 17, wherein the digitally-created token comprises a digitally-created rendering of an object.
19. Inventive Concept 18, wherein the object comprises furniture, electronics, automobiles, artwork, books, window treatments, windows, a fireplace, appliances, food, containers including alcoholic beverage containers, glassware, dishes, silverware, cookware, toys, doors, staircases, cabinets, shelves, and the like.
20. Any of Inventive Concepts 17-19, wherein analyzing the scene for one or more location opportunities for placement of a digitally-created token in the scene comprises detecting surfaces in the scene, calculating positions for placement of the digitally-created token in the scene, and defining constraints for placement of the digitally-created token in the scene.
21. Inventive Concept 20, wherein defining constraints for placement of the digitally-created token in the scene comprises determining eligibility for placement of the digitally-created token in the scene.
22. Inventive Concept 21, wherein determining eligibility for placement of the digitally-created token in the scene comprises determining one or more of sizes of the detected surfaces, angles of the detected surfaces, lighting characteristics of the detected surfaces, and stability of the detected surfaces in the scene.
23. Inventive Concept 22, wherein the analyzing the scene includes determining whether the scene comprises a restaurant, a retail store, an indoor sporting event, a theater or other indoor entertainment venue, a gym, an indoor adventure setting such as a bowling alley, and indoor pool, a skating rink, or participating in other indoor activities.
24. Inventive Concept 23, wherein the analyzing the scene further includes identifying a room of a dwelling including a kitchen, a living room, a den, a bedroom, a dining, room, a bathroom, a laundry room, a basement, a foyer, a hallway, a staircase, an attic, a closet, a storage room, and a garage.
25. Inventive Concept 22, wherein analyzing the scene includes determining whether the scene comprises a rural setting, an urban setting, a city setting, a sporting event, a concert or other outdoor entertainment venue, a vacation setting such as a beach, sea or ocean setting or a mountain setting, an outdoor adventure setting such as hunting, fishing, hiking, camping, or participating in other outdoor activities.
26. Inventive Concept 22, wherein the digitally-created token comprises an advertisement.
27. Inventive Concept 26, further comprising a fourth computer-executable code section for creating an advertising package, wherein the advertising package is comprised of parameters including the determined sizes of the detected surfaces, angles of the detected surfaces, lighting characteristics of the detected surfaces, stability of the detected surfaces in the scene, and scene type.
28. Inventive Concept 27, wherein one of the detected surfaces is selected and an advertisement is selected for placement on the selected detected surface in the scene based on the advertising package.
29. Inventive Concept 28, wherein placing the selected advertisement in the scene comprises creating an anchor on the selected detected surface, rendering the selected advertisement on the selected detected surface in the scene, and displaying the selected advertisement.
30. Inventive Concept 29, wherein a plurality of digitally-created advertisements are stored in a database, each stored advertisement having a plurality of stored features, wherein the parameters of advertising package are compared to the stored features of a plurality of stored advertisements to create a score indicative of a match between the advertising package and each of the plurality of stored advertisements, said scores are ranked, and the stored advertisement most closely associated with the parameters of the advertising package as determined by the ranking is selected.
31. Inventive Concept 29, wherein the advertising package is provided to a real-time bidding process, and wherein a plurality of advertisers bid to place an advertisement in the scene based on the advertisement package.
32. Inventive Concept 31, wherein one of the detected surfaces is selected and the advertisement is selected for placement on the selected detected surface in the scene based on a highest bid among the plurality of advertisers and parameters of the advertising package.
33. Inventive Concept 32, wherein placing the selected advertisement in the scene comprises creating an anchor on the selected detected surface, processing advertisement content received from the highest bidder among the plurality of advertisers, rendering the selected advertisement on the selected detected surface in the scene, and displaying the selected advertisement.
34. A system for placing a digitally-created token in an augmented reality (AR) environment, comprising:
   a device configured for viewing an AR stream of a scene in real-time or in near real-time;
   one or more processors in communication with one or more computer-readable mediums, wherein the one or more processors execute computer-executable code sections stored on the one or more computer-readable mediums to cause the one or more processors to:
      receive the AR stream of the scene;
      analyze the scene for one or more location opportunities for placement of a digitally-created token in the scene; and
      place the digitally-created token at one of the one or more location opportunities in the scene such that the digitally-created token is visible in the AR stream.
35. Inventive Concept 34, wherein the digitally-created token comprises a digitally-created rendering of an object.
36. Inventive Concept 35, wherein the object comprises furniture, electronics, automobiles, artwork, books, window treatments, windows, a fireplace, appliances, food, containers including alcoholic beverage containers, glassware, dishes, silverware, cookware, toys, doors, staircases, cabinets, shelves, and the like.
37. Ay one of Inventive Concepts 34-36, wherein analyzing the scene for one or more location opportunities for placement of a digitally-created token in the scene comprises detecting surfaces in the scene, calculating positions for placement of the digitally-created token in the scene, and defining constraints for placement of the digitally-created token in the scene.
38. Inventive Concept 37, wherein defining constraints for placement of the digitally-created token in the scene comprises determining eligibility for placement of the digitally-created token in the scene.
39. Inventive Concept 38, wherein determining eligibility for placement of the digitally-created token in the scene comprises determining one or more of sizes of the detected surfaces, angles of the detected surfaces, lighting characteristics of the detected surfaces, and stability of the detected surfaces in the scene.
40. Inventive Concept 39, wherein the analyzing the scene includes determining whether the scene comprises a restaurant, a retail store, an indoor sporting event, a theater or other indoor entertainment venue, a gym, an indoor adventure setting such as a bowling alley, and indoor pool, a skating rink, participating in other indoor activities, and the like.
41. Inventive Concept 40, wherein the analyzing the scene further includes identifying a room of a dwelling including a kitchen, a living room, a den, a bedroom, a dining, room, a bathroom, a laundry room, a basement, a foyer, a hallway, a staircase, an attic, a closet, a storage room, a garage, and the like.
42. Inventive Concept 39, wherein the analyzing the scene includes determining whether the scene comprises a rural setting, an urban setting, a city setting, a sporting event, a concert or other outdoor entertainment venue, a vacation setting such as a beach, sea or ocean setting or a mountain setting, an outdoor adventure setting such as hunting, fishing, hiking, camping, or participating in other outdoor activities, and the like.
43. Inventive Concept 34, wherein the digitally-created token comprises an advertisement.
44. Inventive Concept 43, wherein the one or more processors in communication with one or more computer-readable mediums execute computer-executable code sections stored on the one or more computer-readable mediums to cause the one or more processors to create an advertising package, wherein the advertising package is comprised of parameters including the determined sizes of the detected surfaces, angles of the detected surfaces, lighting characteristics of the detected surfaces, and stability of the detected surfaces in the scene.
45. Inventive Concept 44, wherein one of the detected surfaces is selected and an advertisement is selected for placement on the selected detected surface in the scene based on the advertising package.
46. Inventive Concept 45, wherein placing the selected advertisement in the scene comprises creating an anchor on the selected detected surface, rendering the selected advertisement on the selected detected surface in the scene, and displaying the selected advertisement.
47. Inventive Concept 46, further comprising a plurality of digitally-created advertisements stored in a database, each stored advertisement having a plurality of stored features, wherein the one or more processors in communication with one or more computer-readable mediums execute computer-executable code sections stored on the one or more computer-readable mediums to cause the one or more processors to compare parameters of the advertising package to the stored features of a plurality of stored advertisements to create a score indicative of a match between the advertising package and each of the plurality of stored advertisements, said scores are ranked, and the stored advertisement most closely associated with the parameters of the advertising package as determined by the ranking is selected.
48. Inventive Concept 47, further comprising the one or more processors in communication with one or more computer-readable mediums executing computer-executable code sections stored on the one or more computer-readable mediums to cause the one or more processors to provide the advertising package to a real-time bidding process, and wherein a plurality of advertisers bid to place an advertisement in the scene based on the advertisement package.
49. Inventive Concept 48, wherein one of the detected surfaces is selected and the advertisement is selected for placement on the selected detected surface in the scene based on a highest bid among the plurality of advertisers and parameters of the advertising package.
50. Inventive Concept 49, wherein placing the selected advertisement in the scene comprises creating an anchor on the selected detected surface, processing advertisement content received from the highest bidder among the plurality of advertisers, rendering the selected advertisement on the selected detected surface in the scene, and displaying the selected advertisement on a display of the device configured for viewing the AR stream of the scene.
51. Inventive Concept 50, wherein the device configured for viewing the AR stream of the scene comprises a smartphone, a computer (laptop or desktop), virtual reality (VR) or AR glasses, masks, or headsets.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for placing a digitally-created token in an augmented reality (AR) environment, comprising:
receiving, in real-time or near real-time, an augmented reality (AR) stream of a scene;
analyzing the scene for one or more location opportunities for placement of a digitally-created token in the scene; and
placing the digitally-created token at one of the one or more location opportunities in the scene such that the digitally-created token is visible in the AR stream.

2. The method of claim 1, wherein analyzing the scene for one or more location opportunities for placement of a digitally-created token in the scene comprises detecting surfaces in the scene, calculating positions for placement of the digitally-created token in the scene, and defining constraints for placement of the digitally-created token in the scene.

3. The method of claim 2, wherein defining constraints for placement of the digitally-created token in the scene comprises determining eligibility for placement of the digitally-created token in the scene.

4. The method of claim 3, wherein determining eligibility for placement of the digitally-created token in the scene comprises determining one or more of sizes of the detected surfaces, angles of the detected surfaces, lighting characteristics of the detected surfaces, and stability of the detected surfaces in the scene.

5. The method of claim 4, wherein the digitally-created token comprises a digitally-created rendering of an object, and wherein placing the object in the scene comprises creating an anchor on the selected detected surface, rendering the object on the selected detected surface in the scene, and displaying the object.

6. The method of claim 4, wherein the digitally-created token comprises an advertisement.

7. The method of claim 6, further comprising creating an advertising package, wherein the advertising package is comprised of parameters including the determined sizes of the detected surfaces, angles of the detected surfaces, lighting characteristics of the detected surfaces, stability of the detected surfaces in the scene.

8. The method of claim 7, wherein one of the detected surfaces is selected and an advertisement is selected for placement on the selected detected surface in the scene based on the advertising package.

9. The method of claim 8, wherein placing the selected advertisement in the scene comprises creating an anchor on the selected detected surface, rendering the selected advertisement on the selected detected surface in the scene, and displaying the selected advertisement.

10. The method of claim 9, wherein a plurality of digitally-created advertisements are stored in a database, each stored advertisement having a plurality of stored features, wherein the parameters of advertising package are compared to the stored features of a plurality of stored advertisements to create a score indicative of a match between the advertising package and each of the plurality of stored advertisements, said scores are ranked, and the stored advertisement most closely associated with the parameters of the advertising package as determined by the ranking is selected.

11. The method of claim 9, wherein the advertising package is provided to a real-time bidding process, and wherein a plurality of advertisers bid to place an advertisement in the scene based on the advertisement package.

12. The method of claim 11, wherein the advertisement is selected for placement on the selected detected surface in the scene based on a highest bid among the plurality of advertisers and parameters of the advertising package.

13. A non-transitory computer program product comprised of computer-executable code sections stored on one or more computer-readable mediums for implementing a method for placing a digitally-created token in an augmented reality (AR) environment, comprising:
a first computer-executable code section for receiving an AR stream of a scene in real-time or in near real-time;
a second computer-executable code section for analyzing the scene for one or more location opportunities for placement of a digitally-created token in the scene; and
a third computer-executable code section for placing the digitally-created token at one of the one or more location opportunities in the scene such that the digitally-created token is visible in the AR stream.

14. The computer program product of claim 13, wherein analyzing the scene for one or more location opportunities for placement of a digitally-created token in the scene comprises detecting surfaces in the scene, calculating positions for placement of the digitally-created token in the scene, and defining constraints for placement of the digitally-created token in the scene.

15. The computer program product of claim 14, wherein defining constraints for placement of the digitally-created token in the scene comprises determining eligibility for placement of the digitally-created token in the scene.

16. The computer program product of claim 15, wherein determining eligibility for placement of the digitally-created token in the scene comprises determining one or more of sizes of the detected surfaces, angles of the detected surfaces, lighting characteristics of the detected surfaces, and stability of the detected surfaces in the scene.

17. The computer program product of claim 16, wherein the digitally-created token comprises a digitally-created rendering of an object, and wherein placing the object in the scene comprises creating an anchor on the selected detected surface, rendering the object on the selected detected surface in the scene, and displaying the object.

18. The computer program product of claim 16, wherein the digitally-created token comprises an advertisement.

19. The computer program product of claim 18, further comprising a fourth computer-executable code section for creating an advertising package, wherein the advertising package is comprised of parameters including the determined sizes of the detected surfaces, angles of the detected surfaces, lighting characteristics of the detected surfaces, and stability of the detected surfaces in the scene.

20. The computer program product of claim 19, wherein one of the detected surfaces is selected and an advertisement is selected for placement on the selected detected surface in the scene based on the advertising package.

21. The computer program product of claim 20, wherein placing the selected advertisement in the scene comprises creating an anchor on the selected detected surface, rendering the selected advertisement on the selected detected surface in the scene, and displaying the selected advertisement.

22. The computer program product of claim 21, wherein a plurality of digitally-created advertisements are stored in a database, each stored advertisement having a plurality of stored features, wherein the parameters of advertising package are compared to the stored features of a plurality of stored advertisements to create a score indicative of a match between the advertising package and each of the plurality of stored advertisements, said scores are ranked, and the stored advertisement most closely associated with the parameters of the advertising package as determined by the ranking is selected.

23. The computer program product of claim 21, wherein the advertising package is provided to a real-time bidding process, and wherein a plurality of advertisers bid to place an advertisement in the scene based on the advertisement package.

24. The computer program product of claim 24, wherein the advertisement is selected for placement on the selected detected surface in the scene based on a highest bid among the plurality of advertisers and parameters of the advertising package.

25. A system for placing a digitally-created token in an augmented reality (AR) environment, comprising:
a device configured for viewing an AR stream of a scene in real-time or near real-time;
one or more processors in communication with one or more computer-readable mediums, wherein the one or more processors execute computer-executable code sections stored on the one or more computer-readable mediums to cause the one or more processors to:
receive the AR stream of the scene;
analyze the scene for one or more location opportunities for placement of a digitally-created token in the scene; and
place the digitally-created token at one of the one or more location opportunities in the scene such that the digitally-created token is visible in the AR stream.

26. The system of claim 25, wherein analyzing the scene for one or more location opportunities for placement of a digitally-created token in the scene comprises detecting surfaces in the scene, calculating positions for placement of the digitally-created token in the scene, and defining constraints for placement of the digitally-created token in the scene.

27. The system of claim 26, wherein defining constraints for placement of the digitally-created token in the scene comprises determining eligibility for placement of the digitally-created token in the scene.

28. The system of claim 27, wherein determining eligibility for placement of the digitally-created token in the scene comprises determining one or more of sizes of the detected surfaces, angles of the detected surfaces, lighting characteristics of the detected surfaces, and stability of the detected surfaces in the scene.

29. The system of claim 28, wherein the digitally-created token comprises a digitally-created rendering of an object and wherein placing the object in the scene comprises creating an anchor on the selected detected surface, rendering the object on the selected detected surface in the scene, and displaying the object.

30. The system of claim 28, wherein the digitally-created token comprises an advertisement.

31. The system of claim 30, wherein the one or more processors in communication with one or more computer-readable mediums execute computer-executable code sections stored on the one or more computer-readable mediums to cause the one or more processors to create an advertising package, wherein the advertising package is comprised of parameters including the determined sizes of the detected surfaces, angles of the detected surfaces, lighting characteristics of the detected surfaces, stability of the detected surfaces in the scene, and scene type.

32. The system of claim 31, wherein one of the detected surfaces is selected and an advertisement is selected for placement on the selected detected surface in the scene based on the advertising package.

33. The system of claim 32, wherein placing the selected advertisement in the scene comprises creating an anchor on the selected detected surface, rendering the selected advertisement on the selected detected surface in the scene, and displaying the selected advertisement.

34. The system of claim 33, further comprising a plurality of digitally-created advertisements stored in a database, each stored advertisement having a plurality of stored features, wherein the one or more processors in communication with one or more computer-readable mediums execute computer-executable code sections stored on the one or more computer-readable mediums to cause the one or more processors to compare parameters of the advertising package to the stored features of a plurality of stored advertisements to create a score indicative of a match between the advertising package and each of the plurality of stored advertisements, said scores are ranked, and the stored advertisement most closely associated with the parameters of the advertising package as determined by the ranking is selected.

35. The system of claim 33, further comprising the one or more processors in communication with one or more computer-readable mediums executing computer-executable code sections stored on the one or more computer-readable mediums to cause the one or more processors to provide the advertising package to a real-time bidding process, and wherein a plurality of advertisers bid to place an advertisement in the scene based on the advertisement package.

36. The system of claim 35, wherein one of the detected surfaces is selected and the advertisement is selected for placement on the selected detected surface in the scene based on a highest bid among the plurality of advertisers and parameters of the advertising package.

37. The system of claim 25, wherein the device configured for viewing the AR stream of the scene comprises a smartphone, a computer (laptop or desktop), virtual reality (VR) or AR glasses, masks, or headsets.
